(19) United States
(12) Patent Application Publication
(10) Pub. No.: US 2013/0209982 A1
(43) Pub. Date: Aug. 15, 2013

(54) SYSTEM AND METHOD FOR MANAGING AND ADMINISTERING A HIGH STAKES TEST

(71) Applicant: Turning Technologies, LLC, (US)

(72) Inventors: Tina ROOKS, Orlando, FL (US); Dave Chiszar, Naperville, IL (US); Fares Bouchedid, Poland, OH (US); Ronald Phillip Canacci, Youngstown, OH (US)

(73) Assignee: Turning Technologies, LLC, Youngstown, OH (US)

(21) Appl. No.: 13/768,302

(22) Filed: Feb. 15, 2013

Related U.S. Application Data
(60) Provisional application No. 61/599,151, filed on Feb. 15, 2012.
(60) Provisional application No. 61/601,634, filed on Feb. 22, 2012.

(51) Int. Cl. G09B 7/00

(52) U.S. Cl. CPC G09B 7/00
USPC 434/350

(57) ABSTRACT

A method of administering a high stakes test includes providing a proctor device and providing a plurality of response devices, with each response device being associated with one of a plurality of subjects. The method also includes beginning a test and receiving a plurality of signals at the proctor device from the plurality of response devices. The method further includes determining that a first response device associated with a first subject is non-functional and temporarily suspending the test to associate a second response device with the first subject, then resuming the test.

### CROSS-REFERENCE TO RELATED APPLICATIONS

This application claims priority from U.S. Provisional Application No. 61/599,151 filed on Feb. 15, 2012 and U.S. Provisional Application No. 61/601,634 filed on Feb. 22, 2012. The disclosures of both these applications are hereby entirely incorporated by reference.

### FIELD OF INVENTION

The present disclosure relates to the field of testing and assessment administration. More particularly, the present disclosure relates to a system and method for managing and administering a high stakes test.

### BACKGROUND

Standardized tests—and high stakes tests in particular—are often utilized in various industries to test individuals or groups of individuals on various subject matters. Testing materials for proctoring such a test may be distributed electronically to one or more proctor stations or computing devices. Similarly, responses to test questions may be collected electronically. Administering a test electronically, rather than administering the test in paper form, enables a test administrator to more efficiently distribute testing materials to proctors and to collect responses from test subjects.

Additionally, Audience response systems may be used in such testing environments to more efficiently proctor a test. Audience response systems incorporate one or more base units or proctor devices and a plurality of response devices. The response devices receive responses to questions from subjects and wirelessly transmit the responses to a base unit.

Distributing testing materials electronically to proctors may rely on the presence of an Internet connection in the testing center. Similarly, collecting responses from test participants may rely on the presence of an Internet connection. Distributing testing materials and collecting responses in the absence of an Internet connection may be tedious and time consuming for an administrator.

### SUMMARY OF THE INVENTION

In one embodiment, a method of administering a high stakes test includes providing a proctor device and receiving an encrypted offline data package at the proctor device. The proctor device decrypts a first portion of the offline data package and authenticates a user as a proctor using the decrypted portion of the offline data package. The method further includes associating the authenticated user with a test group and decrypting a second portion of the offline data package based on the association. At least one of the first portion and the second portion includes a test roster. The method also includes providing a plurality of response devices, with each response device being associated with one of a plurality of subjects. The method further includes adjusting the test roster according to subjects physically present at a test site. The method also includes beginning a test, receiving a plurality of signals at the proctor device from the plurality of response devices, and ending the test.

In an alternative embodiment, a method of administering a high stakes test includes providing a proctor device and providing a plurality of response devices, with each response device being associated with one of a plurality of subjects. The method further includes beginning a test and receiving a plurality of signals at the proctor device from the plurality of response devices. The method also includes decrypting the plurality of signals by the proctor device into a question identifier, a response identifier, and a response device identifier, and storing the question identifier, the response identifier, and the response device identifier at the proctor device. The question identifier, the response identifier, and the response device identifier are also transmitted from the proctor device to a server. The method also includes ending the test and determining that at least one of an expected response identifier is missing from the server. The method further includes identifying the response device identifier associated with the missing expected response identifier, identifying a proctor device associated with the identified response device identifier, and logging on to the identified proctor device to determine whether the missing expected response identifier is present on the identified proctor device.

In another alternative embodiment, a method of administering a high stakes test includes providing a proctor device and providing a plurality of response devices, with each response device being associated with one of a plurality of subjects. The method also includes beginning a test and receiving a plurality of signals at the proctor device from the plurality of response devices. The method further includes determining that a first response device associated with a first subject is non-functional and temporarily suspending the test to associate a second response device with the first subject, then resuming the test.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is an example diagram of a high stakes testing system.

FIG. 2 is an example workflow for creating an offline file package.

FIG. 3 is a flow chart illustrating a process for creating an offline data package for an offline mode.

FIG. 4 is a flow chart illustrating a process for collecting responses in an offline mode.

FIG. 5 is an example workflow diagram for monitoring battery power of a response device in a high stakes testing system.

FIG. 6 is an example workflow diagram for replacing a malfunctioning response device in a high stakes testing system.

FIG. 7 is an example screen shot of a monitoring system for monitoring live data transmissions in a high stakes testing system.

FIG. 8 is an example workflow diagram for time-stamping information in a high stakes testing system.

FIG. 9 is an example workflow diagram for managing subject attendance in a high stakes testing system.

### DETAILED DESCRIPTION

The following includes definitions of selected terms employed herein.

An “answer key” is a list of questions and question type which may or may not include correct answer indicators.

An “assessment” or a “test” is any single question or group of questions.

A “computer station” includes desktop computer, laptop computer, tablet computer, and all operating systems.

“Logic” includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmed logic device, memory device containing instructions, or the like. Logic may also be fully embodied as software.

A “portal” is a web based application with a database.

A “proctor” is a user, including both human users and computer or mechanic users, which administer the assessment.

A “subject” is a participant recording answer choices for the assessment.

A “test administrator” is an entity administering the assessment and managing the proctors. Test administrators may include a school or educational facility, an employer, a government institution, or other entity.

A “test group” is one or more subjects.

A “test site” is a location for proctoring a test.

The definitions include various examples and/or forms of components that fall within the scope of a term and that may be used for implementation. The examples are not intended to be limiting. Both singular and plural forms of terms may be within the definitions.

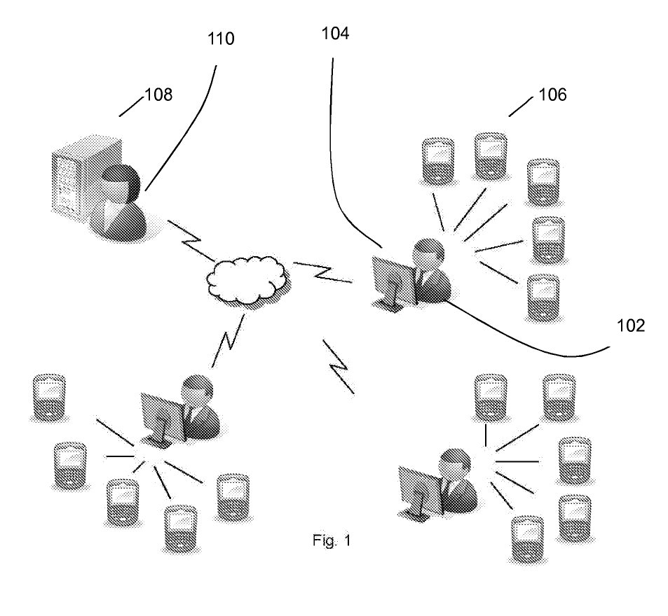

FIG. 1 is an example diagram of a high stakes audience response testing system. A proctor 102 uses a proctor device 104 to administer a test to a particular test group. Multiple proctor devices 104 may be used to simultaneously proctor tests in the same location, and may also be used to simultaneously proctor tests in different locations. Thus, an administrator 110 may administer a test in multiple locations via individual proctors devices 104. In the illustrated embodiment, the proctor device 104 is a computer station. In alternative embodiments (not shown), the proctor device is a plug-in device that interacts with a computer station. In another alternative embodiment (not shown), the proctor device is a mobile phone, or any type of device capable of communicating with response devices via a test proctoring application.

In the illustrated embodiment, subjects us a response device 106 to receive and transmit responses to test questions. In the illustrated embodiment, the response device 106 is a handheld device. In one such embodiment, the handheld device is a dedicated audience response device. In an alternative device, the handheld device is a multipurpose device, such as a smart phone. In other alternative embodiments (not shown) the response device is not a handheld device, but is instead a computer station, or a plug-in device that communicates with a computer station. Alternatively, the response device may be any type of device capable of transmitting test responses to a proctor device.

In one embodiment, the response device 106 communicates with a proctor device 104 via radio frequency (“RF”) or other wired or wireless communication protocol. The proctor devices 104 then transmit received test responses to an administration server via the Internet or other wired or wireless communication protocol. An administration server, as referred to herein, is one or more program applications intended to facilitate the central administration of one or more tests in one or more locations. An administration server facilitates a centralized administration that enables a secure and reliable test event at one or more remote locations, reducing the chance of data loss.

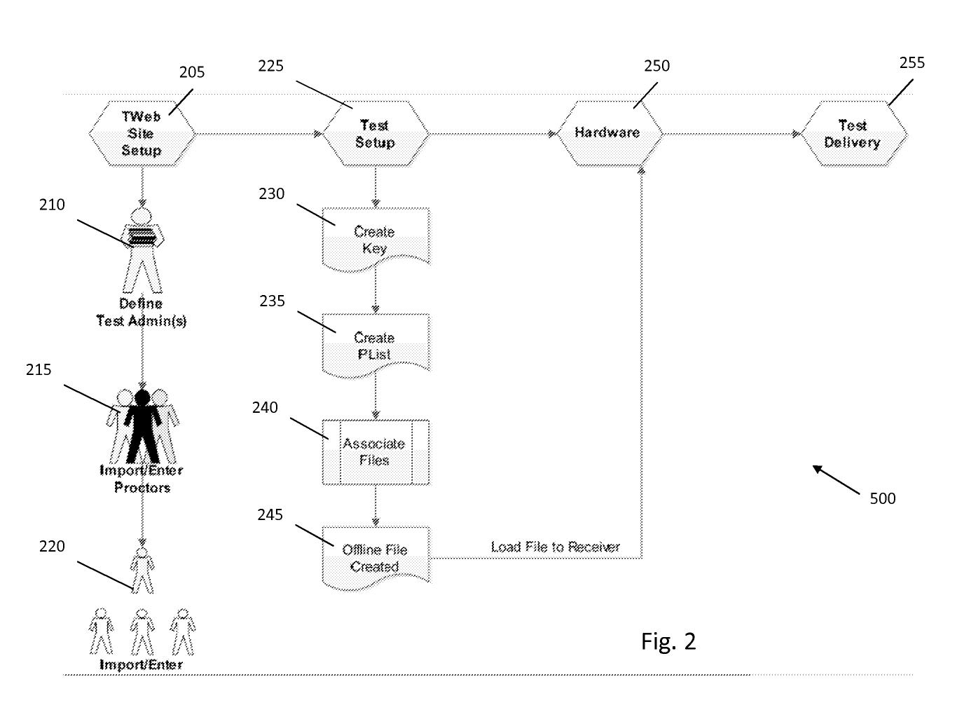

FIG. 2 is an example workflow 200 for creating an offline file package. First, a portal is set up (205). In the portal setup, the test administrators are defined (210) and proctors are also defined (215). The proctors may be defined by importing their credentials from a previous entry. If no previous entry has been made for a given proctor, the new credentials may be entered. In the TWeb setup, the students or other subjects are also defined (220). The subjects may be defined by importing their credentials from a previous entry. If no previous entry has been made for a given subject, the new credentials may be entered.

Once the portal is established, a test is set up (225). The test setup includes creating a key (230), creating a proctor list and participant list (235), and creating or importing associated filed (240) including test questions, test answers, a list of participants of a test group, proctor information and access credentials, information about a specific test site, and so on. An offline file is then created (245) and delivered to the proctor device (250) so that the test may be delivered (255).

An offline mode, according to the example embodiments described herein, enables a test administrator to securely distribute testing materials from an administration server to one or more proctor devices without relying on an Internet connection in a testing center.

To securely distribute testing materials to a proctor, a test administrator encrypts the testing materials, packages the materials into one or more data files, and transfers the data files to the proctor. For convenience, the data files may be packaged into a single data package, such as a .zip file. If the proctor device has access to an Internet connection, a proctor may download the data package from an administration server to the proctor device.

Alternatively, if the proctor device does not have access to an Internet connection, a test administrator may transfer an offline data package from the administration server to the proctor in another suitable manner. For example, an administrator may copy the data package to a memory stick, a CD, a DVD, or to another similar type of memory storage device, and deliver the memory storage device to the proctor. In an example embodiment, the proctor device plays an instructional video for the proctor while testing materials are being transferred to the proctor device. The video may be played while the testing materials are being downloaded from an administration server or while the testing materials are being transferred from a portable storage device, for example.

In an example embodiment, an offline data package includes a user information file. The user information file defines access rights to the testing materials included in the offline data package. The user information file may also define access rights to the proctor device.

Based on data in the user information file, a test proctoring application on the proctor device authenticates a user as an authorized proctor before allowing the user to access the proctor device and the testing materials. Thus, a test proctoring application on the proctor device is able to authenticate a user even in offline mode when an Internet connection is not available.

The user information file contains a list of usernames and corresponding passwords. Each username is given a unique ID and is also assigned a role. For example, a user may be assigned a “proctor” role which may limit the user's access rights. When the user is authenticated as a proctor, the test proctoring application may enable a user to proctor a single test, or a group of tests for a single test group. The test proctoring application maps the authenticated user, based on his role, to a corresponding test group or classroom and grants the user access to materials necessary to proctor a test for that specific test group.

If a user's role is defined to be an “administrator” and the user is authenticated accordingly, the test proctoring application may give the user additional security access to perform additional functions, such as administering multiple tests among multiple test groups. It should be understood that although a “proctor” and an “administrator” role have been described, users may be assigned additional roles in the information file, provided that test proctoring application is configured to interpret the roles and to grant appropriate security clearance to the user.

The following is an example structure of an XML formatted user information file named UserInfo.xml:

<users>

<user>

<id> </id>
<username></username>
<password></password>
<role></role>

</user>

</users>

The example Userinfo.xml file includes a “users” root element which may contain one or more “user” elements. Each user element contains information specific to a user, including an “id” element, a “username” element, a “password” element, and a “role” element. The “id” element is a unique numeric identification number of the user. The “username” element is a unique alphanumeric username of the user. The “password” element is an alphanumeric password specific to the user.

The “role” element is also alphanumeric and defines a role assigned to the user. In one example, a role of “1” may indicate that the user is an assessment administrator responsible for managing administration of the assessment, while a user identified with a role of “2” may indicate that the user is an assessment proctor responsible for proctoring the assessment to a test group. It should be understood that other alphanumeric designations may be used for administrators and proctors.

The offline data package also includes a test site information file. The test site information file is used to map an authenticated proctor to a corresponding test group. Based on the mapping, the test proctoring application may grant the proctor access to appropriate test administration information. If a proctor is associated with multiple test groups, the test proctoring application may allow the proctor to select a current test group for administering a test.

The following is an example structure of an XML formatted test site information file named TestSiteInfo.xml:

<testSite>

<id></id>
<name></name>
<testTypes>

<testType>

<id>1</id>
<name>TypeOne</name>
<order>1</order>
<testDate>12-07-2014</testDate>

</testType>

</testTypes>
<answerKeys>

<answerKey>

<id>8</id>
<typeId>3</typeId>
<name>AnswerKeyOne.tky</name>

</answerKey>

</answerKeys>
<partcipantLists>

<participantList>

<id>1</id>
<name>ParticipantListOne.tpl</name>

</participantList>

</participantLists>
<admins>

<userId>1</userId>
<userId>2</userId>

</admins>
<testGroups>

<testGroup>

<id>1</id>
<name>group one</name>
<proctors>

<userId>1</userId>

</proctors>
<participantList>

<id>1</id>

</participantList>
<answerKeys>

<id>5</id>
<id>8</id>
<id>7</id>

</answerKeys>

</testGroup>
</testGroups>
</testSite>

The example TestSiteInfo.xml file includes a “testSite” root element. The “testSite” root element has some metadata to describe a test site, including an “id” element and a “name” element. A “testSite” element may include additional metadata to describe a test site such as an address of the site, a phone number of the site, and so on, as deemed appropriate by one skilled in the art. Additionally, the “testSite” element has several elements including “testTypes,” “answerKeys,” “participantLists,” “admins,” and “testGroups.”

The “testTypes” element is used to list the tests associated with a test site and to organize the tests into categories. Tests may be categorized according to subjects such as Math, Science, English, and so on. Tests may also be categorized according to other formats, such as grade level or professional certification, as deemed appropriate by one skilled in the art. The “testTypes” element has one or more “testType” elements to enumerate the different tests associated with a given test site. Each “testType” element includes an “id” element which is a unique numeric ID for a test for a specific test site. A “name” element stores a unique alphanumeric name used to describe and categorize the test. For example, a “name” element may include the text “Math.”

A “testType” element further has an “order” element to specify the numeric order in which the test should be administered. For example, if a math test should be administered second in a series of multiple tests, then the “order” element of the “Math” testType will have a value of “2.” In an example embodiment, a test proctoring application may prohibit a proctor from administering a test out of order. In another example embodiment, test proctoring application may allow a proctor to administer a test out of order if the proctor has been authenticated with administrative privileges.

A “testType” element also has a “testDate” element to specify the date that a test is available to be administered to a test group. In an example embodiment, the “testDate” element has a “MM-DD-YYYY” format in which “MM” is a two digit number representing a month, “DD” is a two digit number representing a day, and “YYYY” is a four digit number representing a year. In an example embodiment, a test proctoring application may only allow a proctor to administer a test on the date specified by the “testDate” element.

The “answerKeys” element includes one or more “answerKey” elements to define one or more answer key files. An answer key contains answers for a specific test and is used to proctor the test. A unique numeric ID for identifying an answer key is defined in an “id” element of an “answerKey” element. Each answer key corresponds to a test defined by a testType “element.” Specifically, an “answerKey” element has a “typeId” element for identifying a test ID which corresponds to a test ID defined by an “id” element of a “testType” element. An “answerKey” element also includes a “name” element which identifies an answer key filename. The filename is used to locate the appropriate Answer Key for a given test for the purpose of proctoring the test.

It should be understood that although an answer key is described, other types of files that may be required to proctor a test may also be associated with a test in a similar manner. For example, a file containing questions, a file containing proctor instructions, and so on may also be associated with a test by including additional elements in the “testSite” element.

The “participantLists” element contains one or more “participantList” elements. A “participantList” element identifies a participant list file which defines a list of participants or test takers. It should be understood that a participant list may be associated with one or more tests. A “participantList” element includes an “id” element which uniquely identifies a participant list with a numeric ID. A “participantList” element also includes a “name” element which identifies a participant list filename. The filename is used to locate the appropriate participant list for a given test for the purpose of proctoring the test. Although a “participantList” element has a unique ID, the associated filename will generally be unique as well since a typical operating system does not allow two files of identical names to be saved in the same location. In an example embodiment, two participant lists may be given the same file name but are then stored in different locations. Accordingly, a “participantList” element would require an additional element to identify the location of the file in addition to the name of the file.

The “admins” element includes one or more “userId” elements which identify one or more user IDs corresponding to user IDs defined in the user information file. If a user ID is identified by a “userId” element in the “admins” element, the corresponding user defined in the information file is considered a test site administrator and has administrative access rights for the given test site.

The “testGroups” element contains one or more “testGroup” elements. A “testGroup” element defines a test group, or a list of participants, and associates the group with a specific test or set of questions. Each “testGroup element contains metadata about a test group including a unique numeric ID defined in an “id” element. The metadata of a “testGroup” element also has an alphanumeric name used to describe the test group defined in a “name” element. A test group name is unique within a given test site. For example, a test site may have a number of uniquely named classrooms such as “Room 100,” “Room 200,” and so on. There may not be two classrooms having the same name within the same test site.

A “testGroup” element also includes a “proctors” element which identifies one or more users that have been assigned to proctor one or more tests for a test group. A proctor is identified by an ID which must match an ID defined by an “id” element of a “user” element in a user information file previously discussed. Accordingly, only authenticated users are authorized to proctor an exam. In an example embodiment, a proctor may only be assigned to proctor a single test at a test site for a given time.

A “testGroup” element also includes a “participantList” element which specifies a participant list ID. The participant list ID is used to identify a list of participants associated with a test group by referencing the “participantLists” element described above. In an example embodiment, a test group may be associated with multiple participant lists and therefore the “participantList” element for a given test group may specify multiple participant list IDs.

A “testGroup” element also includes an “answerKeys” element which specifies one or more answer key IDs in one or more “id” elements. An answer key ID associates a test group with a particular answer key by referencing the “answerKeys” element of the “testSite” element described.

In addition to the user information file and the test site information file, the offline data package also includes two folders, including a first folder for storing answer key files and a second folder for storing participant list files. In an example embodiment, an “AnswerKeys” folder contains answer key files having a “.tky” file format extension and a “ParticipantLists” folder contains participant list filed having a “.tpl” file format extension. File names identified by the “name” elements of the “answerKey” element and the “participantList” element reference files stored in these two folders respectively.

It should be appreciated that the names of the various elements described herein can be modified as deemed appropriate by one skilled in the art without deviating from the intended scope of the present disclosure.

All files contained in an offline package, including the user information file, the test site information file, all answer key files, and all participant list files, are encrypted before being transferred to a test proctor or test administrator to ensure that only users with valid proctor credentials will be able to access the assessment files.

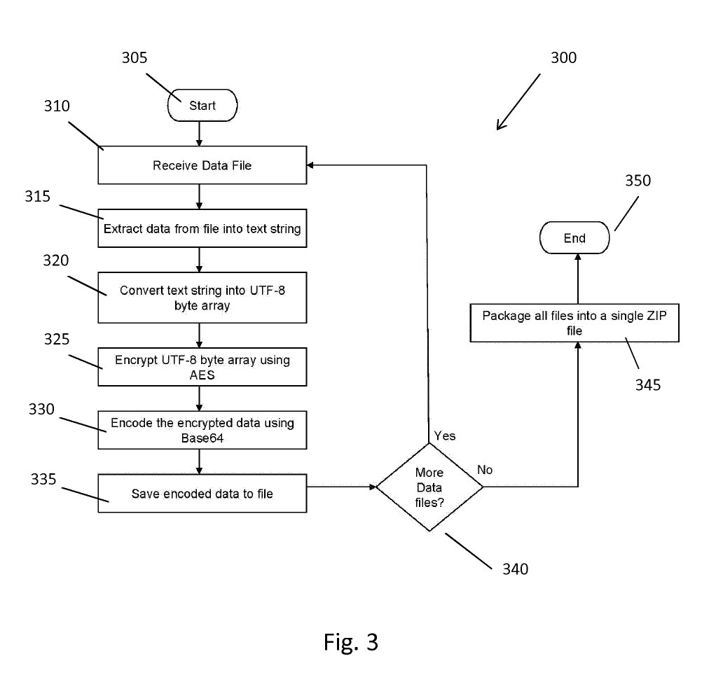

FIG. 3 is a flow chart 300 illustrating an exemplary process for creating an offline data package for an offline mode. To begin the process (305), data files are received (310). To encrypt a data file in one embodiment, data from the file is first extracted into string form (315). The data string is then converted to an eight bit Universal Character Set Transformation Format (UTF-8) byte array (320). The UTF-8 byte array is then encrypted using Advanced Encryption Standard (AES) (325). The AES encrypted data is then Base64 encoded (330). The Base64 encoded data is then saved to a file with an appropriate file extension such as .xml (335). After the Base64 encoded data is saved to a file, the system determined if additional data files are needed (340). If so, it returns to step 310 and repeats the process.

Once all of the files are encrypted, the secured files are prepared for distribution to test proctors by being zipped up into a single offline data package and given an appropriate file extension (345). For example, the offline data package may be named “Assessment2012.offline.”

It should be understood that the encryption process shown in FIG. 3 is merely exemplary and that other known encryption methods may be employed instead.

The files of the offline data package must be decrypted before they can be accessed by a proctor and a test proctoring application to administer a test. In one known embodiment, a decryption process similar to the encryption process of FIG. 3 is employed. When initiated, a test proctoring application first decrypts the user information file to validate the user as an authorized proctor and to establish a role for the user. If the user is not authenticated properly, the test proctoring application will not proceed with decrypting any of the remaining files and therefore will block the user from accessing the test materials.

When the user is successfully authenticated, the test proctoring application decrypts the test site information file so that the test proctoring application can cross-reference the authenticated proctor's ID and determine which Test Groups a proctor has been assigned to. The test proctoring application then decrypts the corresponding answer key and participant list files as required by the proctor to administer the test to the test group. It should be appreciated that the only answer key files and participant list files decrypted are those that are associated with a test group for which a user has been authenticated as being a proctor. An authenticated proctor may be denied access to testing materials associated with other test groups unless the proctor is given an administrator role.

In an example embodiment, as an additional security feature, files of the offline data package are only temporarily decrypted in memory of a computing device executing the test proctoring application. The files are not stored in a decrypted state on the computing device.

In an example embodiment, the files in the offline data package are generated by Turning Technologies HIGH STAKES TURNINGWEB application and the files are configured to be compatible with, and to be utilized by, Turning Technologies HIGH STAKES DESKTOP APPLICATION.

Once a proctor obtains testing materials, the proctor may distribute test questions and begin to the proctor a test. In an example embodiment, test questions are distributed in paper form. In another example embodiment, test questions may be transmitted electronically from the proctor device to the response devices. A participant enters responses on a response device. In one embodiment, the response device forwards the responses to the proctoring device by RF or by another short range communication protocol. In alternative embodiments, any communication protocol may be employed.

The proctoring device then transmits the responses to an administration server, via an Internet connection or other communication protocol. In an alternative embodiment, the response device is capable of connecting to the Internet, and transmits answers directly to the administration server.

A second offline mode for data collection also enables a test administrator to securely collect test answers from response devices or from a proctor device, once a test is complete, without relying on an Internet connection. An assessment administrator application enables an administrator to review test responses from various test groups and to identify if any test responses are missing.

In one example, an administrator may use the assessment administrator application to determine that participants in test group “Room 101” have not properly submitted answers to “Math” test. It may be the case that responses of a test group were transferred to a proctor device via RF at the conclusion of a test but the responses may not have been properly transferred to an administration server because of a lack of an Internet connection. In another example, the responses of the test group may never have been transferred to the proctor device. Thus, the assessment administrator application enables an administrator to retrieve missing responses either from a proctor device or from a response device directly.

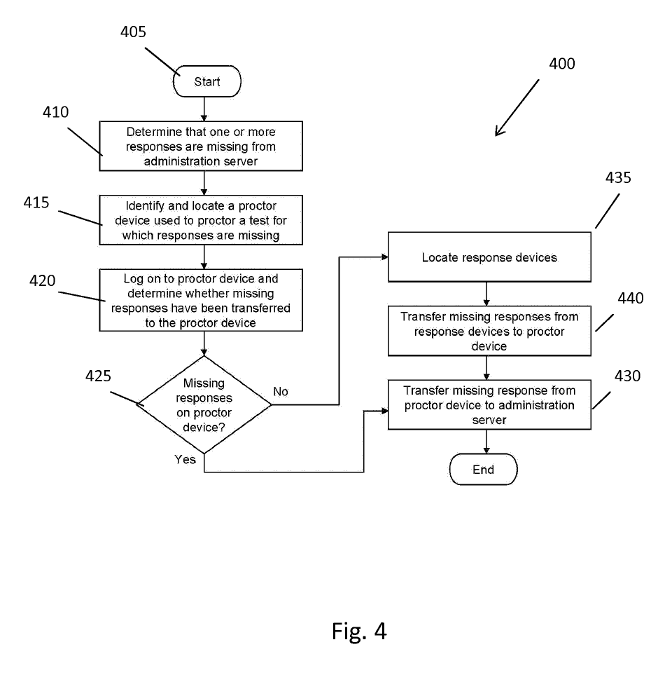

FIG. 4 is a flow chart illustrating a process 400 for collecting responses in an offline mode. An administrator first logs into the assessment administrator application (405) to determine whether any set of test responses have not yet been properly transferred to an administration server (410). The assessment administrator application enables the administrator to view the status of tests corresponding to various test groups. For example, the assessment administrator application may display a list of all test groups along with a status notification for each test group indicating whether the tests for a given test group have been successfully received at the administration server. The test groups may be displayed in a list form, in a table form, or in any other suitable form.

The assessment administrator application also stores information about the response devices used by a test group to respond to test questions as well as information about the proctor device used to proctor the test. For example, the assessment administrator application stores ID numbers of the response devices and of the proctor device. Thus, when the assessment administrator application identifies a test group as not having properly submitted all test responses to the administration server at the conclusion of a test, the assessment administrator application may identify response devices and the proctor device, based on the IDs used to administer the test to the test group (415). In one known embodiment, the test administrator application provides an administrator with a printout of the identified proctor device and response devices.

Since responses are transferred to the proctor device before being uploaded to the administration server, the administrator may first physically locate the identified proctor device to determine whether the proctor device used to proctor the test for the test group contains the responses (415). When the administrator locates the proctor device used to proctor the test for the test group as identified by the assessment administrator application, the administrator logs in to a test proctoring application on the proctor device (420). Upon logging in, the test proctoring application automatically determines the test group for which the proctor device was most recently used to proctor a test.

In an example embodiment, data stored on a proctor device is cleared out before the proctor device is used to proctor a new test. Thus, the test proctoring application only determines a single test group for which the proctor device was recently used to proctor a test. In another example, a proctor device may store data relating to multiple test groups or multiple test proctoring sessions before being cleared out. Thus, the test proctoring application may determine more than one test group for which the proctor device was recently used to proctor a test. In this case, the test proctoring application prompts the administrator to select a test group.

To identify the test group or groups, the test proctoring application searches the proctor device for session log files and checks each session log file for a test group ID. Upon identifying a session log file corresponding to the test group for which the administrator is attempting to retrieve responses, the test proctoring application automatically retrieves, from the administration server, a list of test sessions corresponding to the test group and displays the sessions to the administrator. For example, test program application may display a “Math” session, a “Science” session, and a “Reading” session for a given test group.

The test proctoring application also displays the status of each session to the administrator. Specifically, the test proctoring application displays whether the responses associated with a session have been successfully uploaded to the administration server by all participants of the test group, whether the responses have not been successfully uploaded to the administration server but are present on the proctor device, or whether the responses are neither present on the administration server or on the proctor device. For example, test proctoring application may display a status of either “Web” to indicate that responses have been successfully uploaded to the administration server, a status of “Device” to indicate that the responses are present on the proctor device, or “X” to indicate that the responses are neither present on the administration server or on the proctor device.

If a status of a session indicates that responses have been successfully uploaded to the administration server, the administrator does not need to take any further action for that specific session.

If a status of a session indicates that the responses are present on the proctor device but have not yet been successfully uploaded to the administration server (425), the administrator initiates an upload procedure which transfers responses from the proctor device to the administration server for the selected session (430). For example, an administrator may determine that a test group's responses for a “Math” session and for a “Science” session have been successfully uploaded to the administration server but that the test group's responses to the “Reading” session have not yet been uploaded to the administration server. Accordingly, the administrator will initiate a process to transfer responses for the “Reading” session to the administration server. In an example embodiment, the test proctoring application displays the sessions and the corresponding statuses in a table view. In an example embodiment, the transfer process can be initiated by a button or by another similar type of control presented to the administrator in the table view.

If a status of a session indicates that the responses for that session are neither present on the administration server or on the proctor device (425), or if the test proctoring application is not able to identify a session log file corresponding to the test group for which the administrator is attempting to retrieve responses, the administrator proceeds to locate the response devices to attempt to retrieve the responses from the response devices directly (435). It should be understood that the test proctoring application will indicate that responses for a session are not present on the administration server or on the proctor device even if a subset of participants of a test group did successfully transfer their responses for that session to the administration server. In other words, a status of “X” could mean that some participants of a test group have successfully uploaded responses to the “Math” session while other participants of the test group have not yet successfully uploaded responses to the “Math” session. In an example embodiment, the test proctoring application may distinguish the status of a partially uploaded session from a session in which no responses have been uploaded.

Once the response devices are located and are within range of the proctor device to communicate with the proctor device by RF, the administrator initiates a process to begin to transfer responses from the response devices. The responses may be transferred to the administration server via the proctor device if the response devices don't have Internet connection capability (440, 445). If the response devices do have Internet connection capability, the responses may be transferred to the administration server directly. In an example embodiment, the transfer process can be initiated by a button or other similar control presented to the administrator in the table view. For example, a “Get Data From Response Devices” button may initiate the process.

Once the administrator initiates the process, the test proctoring application determines the response devices used to administer the test to the test group by examining a participation list file, either by accessing an offline data package or by accessing the administration server.

The test proctoring application then presents a list of response devices to the administrator and provides the administrator with a status for each response device, indicating whether responses from the individual response device have been successfully uploaded to the administration server. In an example embodiment, the test proctoring application also presents the names of the participants of the test group in association with the list of response devices. Thus an administrator may look at the list and determine specifically which test participants did not successfully upload responses for a given session.

Once the administrator identifies the response devices and the participants that did not successfully upload responses to the administration server, the administrator may initiate transferring responses from the response devices.

In an example embodiment, a “Get All Missing Responses” button may initiate a process for transferring all responses from all response devices that have not yet been uploaded to the administration server. In an example embodiment, a “Get From Selected Devices” button may initiate a process for transferring responses only from response devices selected by the administrator. The administrator may select certain response devices or participants by checking corresponding checkboxes in a user interface or by clicking on participant names, for example.

In some instances, a response device is powered by a battery and is therefore limited to operating for a certain length of time before the battery needs to be replaced or recharged. If a response device stops functioning during a test as a result of insufficient battery power, a user's testing experience may be negatively impacted. In addition, data may be lost if not properly stored prior to the response device losing battery power. This may require a user to re-enter responses to certain questions. To help prevent disruptions in a user's test taking experience, a response device's battery power is monitored.

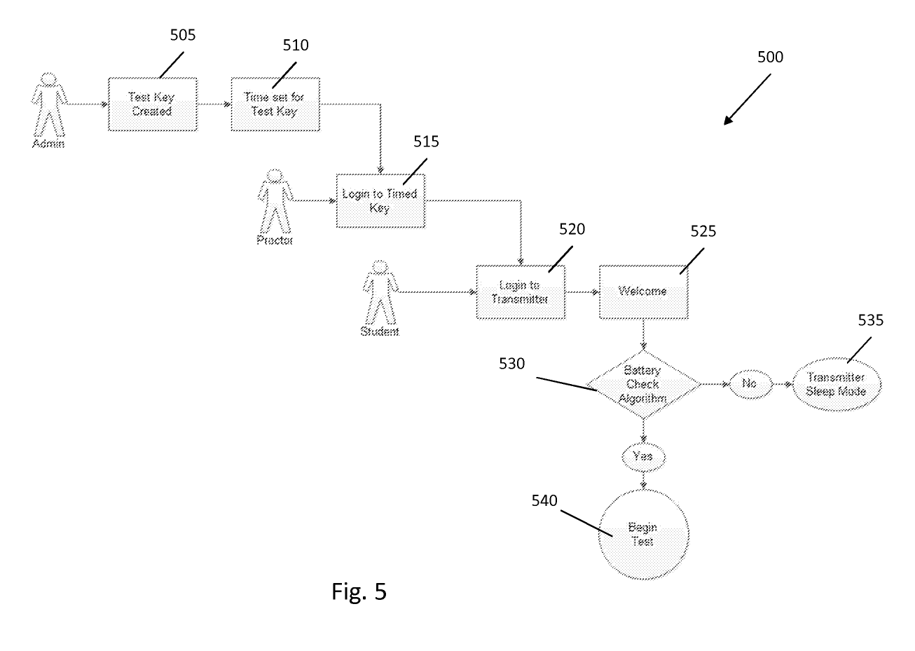

FIG. 5 is an example workflow diagram 500 for monitoring battery power of a response device in a high stakes testing system. When an administrator creates a test (505), the administrator also defines certain parameters of the test, including a time parameter for a test (510). For example, an administrator may specify that a test may not run longer than one hour.

The administrator provides the parameters, including the time parameter, to a proctor who then uses the parameters to proctor the test. Before a proctor begins to proctor the test, the proctor verifies that all response devices have sufficient battery power remaining to function properly for the duration of the test according to the specified time parameter.

A response device may include a power indicator that indicates whether or not the response device has enough remaining power to function properly for the duration of the exam. If the power indicator shows that a response device has sufficient battery power, a user may either proceed with taking the test using the assigned response device. If the power indicator indicates insufficient battery power, the user may request a new response device.

In one embodiment, a power indicator may be an LED. The LED may illuminate to indicate the battery status. In an example embodiment, the LED may illuminate a first color, such as red, to indicate that the battery does not have sufficient remaining power to function properly for the duration of the test while the LED may illuminate a second color, such as green, to indicate that the battery does have sufficient remaining power to function properly for the duration of the test. It should be understood that although an LED has been used as an example power indicator, other suitable indicators, such as an LCD display, an audio speaker, etc. or any combination of suitable indicators may be used as well.

To determine whether or not a response device has sufficient battery power to function properly for the duration of a test, a power monitor algorithm first determines the current charge state of a battery in a response device before a user begins a test. For example, the power monitor algorithm may determine that a battery is charged to 75% of capacity, or that the battery is 25% depleted. The power monitor algorithm then determines the estimated length of time a response device may continue to function properly based on the current battery capacity and based on a predetermined value for the length of time a response device may function properly when the battery is charged to full capacity. For example, if a response device has been determined to function, on average, for eight hours on a fully charged battery and the power monitor algorithm has determined that a battery in a response device is currently charged to 75% capacity, then power monitor algorithm estimates that the response device may continue to function properly for an additional six hours.

The power monitor algorithm next compares the estimated time a response device may continue to function properly with the specified time parameter for the test. If the power monitor algorithm determines that the estimated time is less than the specified time, the power monitor algorithm provides a corresponding indication via the power indicator. In an example embodiment, the power monitor algorithm also provides a corresponding indication via the power indicator upon determining that the estimated time is equal to or greater than the specified time.

In an example embodiment, after the proctor logs in to the proctor device and confirms the time parameter (515), and after the subject logs in to a response device (520), the response device may display an opening message to the subject (525) and run the power monitoring algorithm (530). The power monitoring algorithm provides to the proctor device or to the administration server, the indication of whether or not a response device may continue to function properly for the duration of a test. Such an indication may be either in addition to or in place of the indication provided to the power indicator on the response device.

For example, rather than relying on each individual user associated with the different response devices to check their power indicators before beginning a test to ensure their response device has sufficient battery power to complete the test, a proctor or an administrator may check the status of all response devices via a single power indicator interface. A proctor device or an administration server may present, via a user interface screen, a list of all response devices and corresponding power indications for each device. A proctor or an administrator may review the list and take appropriate action, such as replacing a particular response device with a new response device, based on the power indications.

In an example embodiment, the power monitor algorithm is processed by the response device. In another embodiment, either the proctor device or the administration server processes the power monitor algorithm.

In an example embodiment, a response device may automatically enter a sleep mode and prevent a user from proceeding with a test when the power monitor algorithm determines that the response device does not have sufficient battery power to function properly for the duration of the test (535). If the power monitor algorithm determines that the response device does have sufficient battery power, then the subject may begin the test at the appropriate start time (540).

The power indicator is intended to help prevent a user from beginning a test using a response device when the response device is unlikely to function properly for the duration of the test. Whether a response device will function properly for the duration of a test is not always predictable, however. A battery might fail prematurely. Additionally, a response device may stop functioning in the middle of a test for reasons other than low battery power. Similarly, a proctor device may also stop functioning during an exam. In such a case, the administration server facilitates replacing a malfunctioning response device or proctor device with a functional one in the middle of a test with minimal disruption to the user and without the user experiencing any data lose.

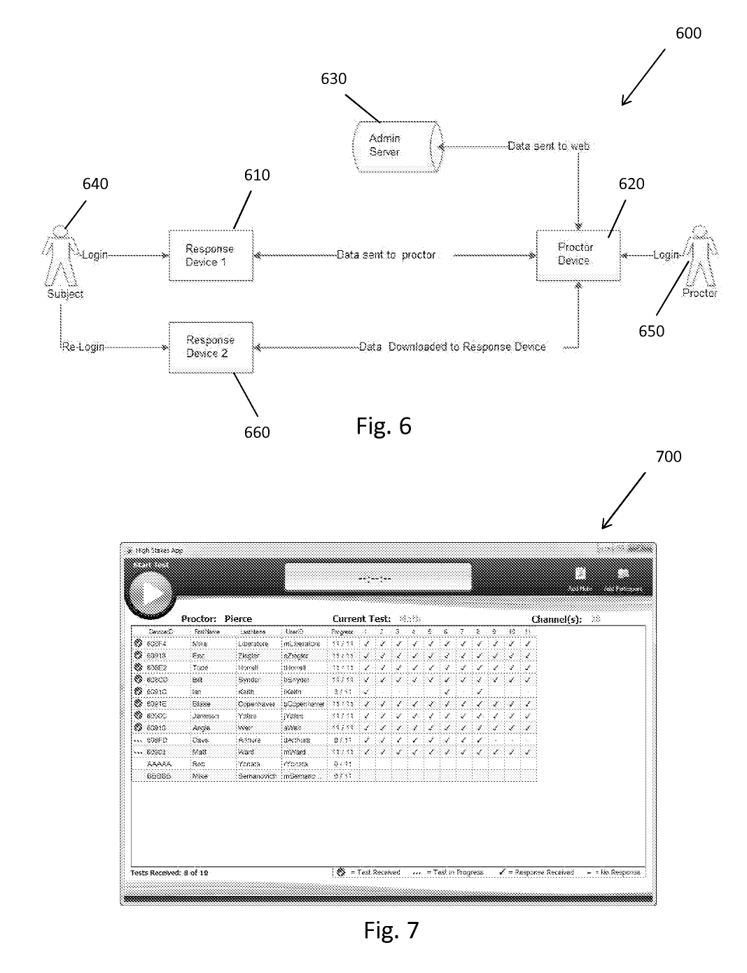

FIG. 6 is an example workflow diagram 600 for replacing a malfunctioning response device in a high stakes testing system. While a first response device 610 is functioning properly, the first response device 610 transmits responses, to a proctor device 620. Responses are stored at the proctor device 620 and eventually transmitted to an administration server 630.

If the first response device 610 stops functioning properly a subject 640 using the response device may notify a proctor 650. Alternatively, the proctor device 620 may automatically detect inactivity by the first response device 610 and notify the proctor 650 accordingly. The proctor 650 may then verify with the subject 640 whether the first response device 610 is functioning properly.

When the first response device 610 stops functioning properly, the proctor 650 takes note of the incident and identifies the first response device 610 as inactive at the proctor device 620. Identifying the first response device 610 as inactive may include clicking a button or a checkbox associated with first response device 610, for example via a user interface at the proctor device 620. Once the first response device 610 is indicated as inactive, the proctor device 620 will consider the subject 640 associated with the first response device 610 as being on hold and will not receive any further responses from the subject 640 until the subject 640 is associated with a second response device 660.

While marked as inactive, the first response device 610 may be replaced with the second response device 660. The second response device 660 is indicated as a replacement device at the proctor device 620 by the proctor 650. For example, the proctor 650 may input an identification number associated with the second response device 660 into a user interface at the proctor device 620 to associate the second response device 660 with the subject 640. Once the second response device 660 is associated with the subject 640, the proctor 650 may activate the second response device 660 at the proctor device 620 via the proctor device interface.

Upon the second response device 660 being activated, the subject 640 may continue to respond to test questions. Since previous responses submitted by the subject 640 have already been transferred to the proctor device 620, and possibly to the administration server 630 as well, no data is lost during the swap-out of first response device 610. The subject 640 may resume answering questions as if the interruption never occurred. For final assessment and scoring, the responses submitted via the new response device will be associated with the subject 640 just as the responses submitted by the previous response device will be associated with the same subject 640.

In an example embodiment, responses received from the first response device 610 as well as responses received from the second response device 660 are all associated as a single set of data at the proctor device 620 and subsequently at the administration server 630. Storing all of the data as a single set enables efficient analysis of the data without regard to whether the data was received from a single response device or from multiple response devices.

In another example embodiment, responses received from the first and second response devices 610, 660 are stored in two or more data sets and later combined into a single data set for reporting and analysis purposes. This eliminates the need for extra processing on the data at the time the data is received from the response devices.

In either example however, information about the one or more response devices associated with a subject are stored in the data set for future reporting and analysis. Thus, if an administrator determines that certain data may be missing or corrupted, the administrator may identify the response devices(s) assigned a subject during a test.

Certain test formats may require a subject to be capable of navigating back to previously answered questions during the test. In such cases, simply enabling a subject 640 to resume a test with a new response device at a previously suspended location is not sufficient. Accordingly, in an example embodiment, all previous responses submitted via a first response device 610 are loaded onto the second response device 660 before the second response device 660 is activated. Previous responses may be transferred directly from the proctor device 620 onto the second response device 660, if responses have been stored at the proctor device 620. Alternatively, the responses may be transferred from the administration server 630 to the second response device 660, via the proctor device 620.

In an example embodiment, it may not be necessary to completely transfer the previous data set of responses to the second response device before the second response device is activated and the subject is allowed to proceed with the test. For example, if the subject does not require the complete data set of previous responses in order to begin the next question, the subject may be given permission to proceed with the test while the previous responses are downloaded concurrently with the subject responding to new questions.

In another example embodiment, when it is critical for multiple test takers to be responding to the same questions concurrently, a proctor or an administrator may choose to temporarily suspend the entire test and prevent all subjects from proceeding with the test until the defective response device is replaced with a new response device. In an example embodiment, a proctor device or an administration server may automatically suspend the proctoring of a test and prevent any subjects from proceeding with the test until the defective response device is replaced with a new response device. In alternative embodiments, a test is only suspended for the subject experiencing a malfunctioning response device while the remaining subjects are allowed to proceed with the test.

In the event that a proctor device malfunctions during an exam, the malfunctioning proctor device may similarly be replaced with a new proctor device without interrupting a subject's test taking experience. In other words, subjects may be allowed to continue to respond to questions while the proctor device is being replaced with a new proctor device.

An administrator may be notified of a defective proctor device by a proctor when the proctor device stops functioning properly. Alternatively, the administration server may automatically detect inactivity by a proctor device and notify the administrator. The administrator may then verify with the proctor whether the proctor device is functioning properly.

When a proctor device stops functioning properly, an administrator takes note of the incident and identifies the proctor device as inactive at the administration server. Identifying the proctor device as inactive may include clicking a button or a checkbox associated with proctor device, for example, via a user interface at the administration server. Once a proctor device is indicated as inactive, the administration server will consider a proctor associated with the proctor device as being on hold and will not receive any further data from the proctor until the proctor is associated with a new proctor device.

While marked as inactive, the non-functioning proctor device may be replaced with a new proctor device. The new proctor device is indicated as a replacement device at the administration server by an administrator. For example, an administrator may input an identification number associated with proctor device into a user interface at the administration server to associate the new proctor device with the proctor of the previous, non-functioning proctor device. Once associated with the proctor, the administrator may activate the new proctor device at the administration server.

Upon the new proctor device being activated, the proctor may continue to proctor the test via the new proctor device. While the proctor device is being replaced, subjects may continue to respond to questions via response devices. Even though the proctor device is not functioning and therefore unable to receive data, responses are stored at each individual response device and queued for transmission to the proctor device. Once the proctor device is replaced and the connections between the response devices and the proctor device are restored, the response devices again begin to transfer responses to the proctor device.

A particular test format, such as an adaptive test, may require a proctor device to have access to previous responses in order to generate next questions for a subject. Thus, simply enabling a proctor to resume proctoring a test with a new proctor device is not sufficient. Accordingly, in an example embodiment, subjects are suspended from proceeding with a test until a replacement proctor device is activated. All previous responses transmitted by a first proctor device to an administration server are loaded back onto the new proctor device before the new proctor device is activated.

When a proctor device or a response device has been swapped out for a new one, a proctor may wish to monitor the progress of one or more subjects to verify that responses are being submitted properly. Additionally, a proctor may wish to monitor responses as they are being submitted for reasons other than to verify operation of devices. Accordingly, the administration server and the proctor device enable an administrator or a proctor, respectively, to monitor a subject's responses in real time.

FIG. 7 is an example screen shot 700 of a monitoring system for monitoring live data transmissions in a high stakes testing system. The monitoring system may be used by either a proctor at a proctor device or by an administrator at an administration server to view live data as responses are being submitted by subjects at test sites. The monitoring system displays a data table comprising one or more rows of data, each row in the table representing an individual subject. Each row of data displays at least one of a subject's name, a user ID, and the subject's response device ID to associate the subject with a response device. The row of data also indicates the subject's progress within a test. For example, a progress field in the row may indicate that the subject has already submitted seven out of ten questions.

A row of data representing a subject also indicates test questions for which a subject has already submitted a response as well as test questions for which a subject has not yet submitted responses. For example, a row may contain 10 columns, or fields, each column representing a different test question. A column within a row may be marked with a check if the subject represented by that row has submitted a response for the question represented by that column. Similarly, the column may be blank or may be marked with some other symbol such as an “X” to indicate that the subject has not yet submitted an answer for that question.

In an example embodiment, responses are time stamped when they are transmitted by the response device, when received by the proctor device, or at both instances. Time stamping the data enables a proctor or an administrator to perform various types of analysis on the data such as detecting sequences, patterns, rates, and other statistics. For example, a proctor may determine that a particular subject is consistently taking longer to respond to questions as compared to an average time that the remaining students are taking to respond to questions. The average response time may be calculated by the monitoring system based on other subjects' response times. A subject may have a difficult time finishing a test in the allowed time if the subject is consistently responding to questions more slowly than the average subject. Accordingly, the monitoring system may notify the proctor of this potential issue.

Similarly, a proctor may determine that a particular subject is responding to questions consistently faster than the average. This may be an indication that the subject is responding to questions randomly. Accordingly, the monitoring system may notify the proctor of this potential issue.

In an example embodiment, the monitoring system may detect when two subjects are submitting identical or nearly identical responses. This may be an indication that one or both of the subjects are cheating. In an example embodiment, the monitoring system utilizes a seating chart to further analyze whether a subject may be cheating. For example, if two subjects are determined to be submitting identical answers and are also determined to be sitting next to each other, based on the seating chart, than the two subjects may be identified as highly likely cheaters. On the other hand, if two subjects are determined to be submitting identical answers but are determined not to be sitting next to each other, based on the seating chart, than the two subjects may be identified as possible cheaters.

In an example embodiment, the monitoring system is configured to immediately alert a proctor or an administrator when a potential cheater is identified. Generated alerts may be an email, a text message, a telephone call, an audible alert at the proctor device or at the administration server, a visible alert at the proctor device or at the administration server, and any combination thereof or by any other suitable means. In another example embodiment, the monitoring system is configured to flag the one or more subjects rather than immediately alerting a proctor or an administrator. The flag may be displayed in the data table within a row of a corresponding subject.

In an example embodiment, a response submitted by a subject is time-stamped by a response device before the response is transmitted to a proctor device. In another example embodiment, the response is time-stamped by a proctor device after it is received by the proctor device. In yet another example embodiment, the response is time-stamped both by the response device before being transmitted by the response device and by the proctor device. Having two time stamps enables an administrator at the administration server to compare the data and to verify that subject's time stamps align with proctor time stamps. This provides verification that test events occur as expected.

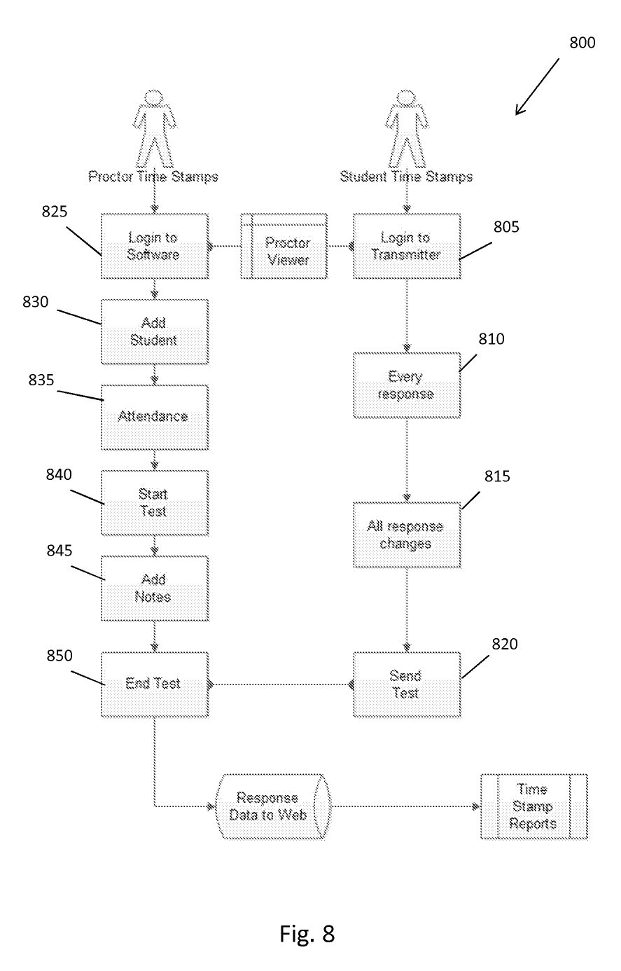

In an example embodiment, all events of a test are time-stamped. FIG. 8 is an example workflow diagram 800 for time-stamping information in a high stakes testing system. Every button pressed on a response device is time-stamped, including logging in to a response device (805), responding to questions (810), changing responses (815), and submitting a completed test (820). Every button pressed on a proctor device is also time-stamped, including logging in to the proctor device (825), adding a subject to a test (830), verifying attendance at a test (835), starting a test (840), adding notes during a test (845), and ending a test (850). It should be understood that additional events may be time-stamped as deemed appropriate by an administrator.

Having detailed time-stamped data enables an administrator to ensure a high level of security during the proctoring of a test and also enables an administrator to perform various analyses while the test is being proctored as well as after the test has been completed. For example, an administrator can perform statistical analysis of response times for individual subjects or for various groups of subjects. Statistical groups can be identified based on geography, or based on other demographic information, for example.

An administrator may also use the data to analyze the quality of the questions used. For example, if a specific question was consistently answered in less than average time by a majority of subjects, an administrator may infer that the question was easy. Similarly, an administrator may infer that a specific question was difficult if a majority of subjects took longer, on average, to answer the question as compared to average time.

In an example embodiment, the monitoring system also enables a proctor or an administrator to generate reports based on the various statistical data collected and analyzed. For example, the monitoring system may generate a report indicating the inferred difficulty level of all questions in a test, based on the response times of all subjects.

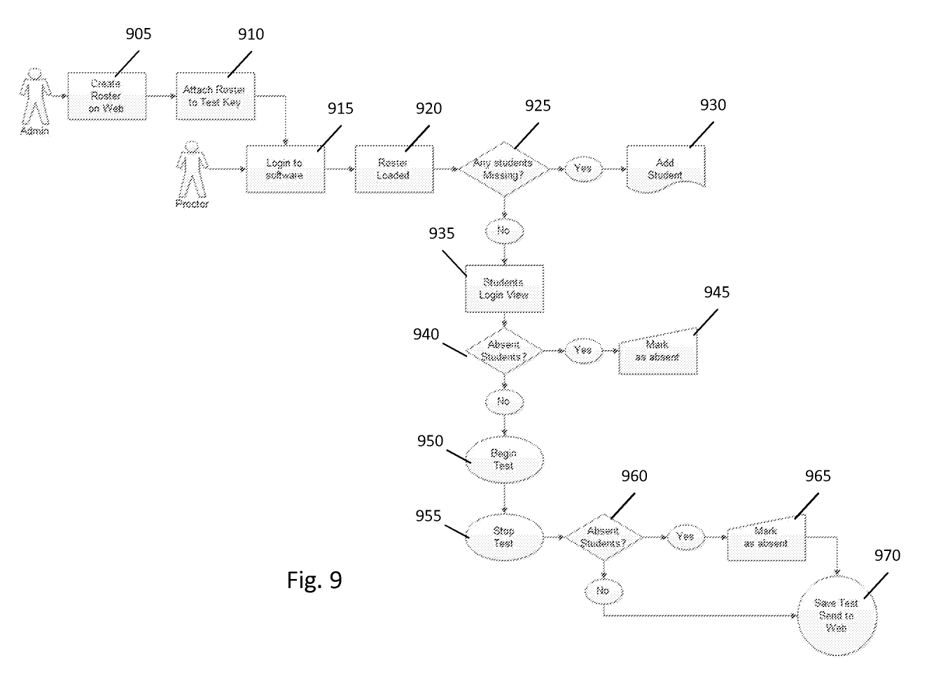

The administration server and the proctor device also enable an administrator or a proctor, respectively, to manage the attendance at a test. FIG. 9 is an example flow diagram 900 for managing subject attendance in a high stakes testing system. Prior to a test being proctored, a subject roster is created (905) and attached to a test key (910) to indicate the expected subjects to be present at a test site.

Before a proctor begins a test, the proctor logs in (915) and loads the roster (920). The proctor may then review the roster and make adjustments if needed (925). For example, a proctor may manually add or remove subjects from the roster if the proctor knows that the roster is not properly updated, based on the subjects present in a room (930). In an example embodiment, an administrator may be notified if a proctor modifies a roster. Alternatively, an administrator may choose to lock the roster and therefore not allow the proctor to add or remove any subjects from the roster unless given permission by an administrator.

In an example embodiment, after adjusting the roster, the proctor reviews the final roster (935) and determines if any students are absent (940). The proctor may mark a subject as absent if the subject is not present (945), rather than delete the subject from the roster. Similarly, a proctor may mark a subject as present before beginning the test. This may help an administrator determine which, if any, subjects that were expected to be present for a test did not show up.

In an example embodiment, a subject is automatically detected as present or not by a monitoring system at a proctor device, based on data received (or not received) from response devices. For example, a monitoring system may automatically mark a subject as present when the subject logs into a response device. Similarly, the monitoring system may mark a subject as absent if the subject has not logged in at the time the proctor begins the test. In another example embodiment, the monitoring system automatically marks a subject as present after the proctor device receives at least one response from the subject's response device. Similarly, the monitoring system may mark a subject as absent if the monitoring system has determined that a subject has not submitted any responses during a test.

After attendance is taken, the test begins (950) and runs for the allotted amount of time until the test ends, or until all of the subjects have completed the test (955).

In an example embodiment, a proctor may check attendance during or after the test (960) and mark a subject as absent (965), or flagged in some other way, after the test has already begun—even if the subject was initially marked as present. For example, a subject may have logged into a response device before the test began and was therefore automatically marked as present. However, the subject may have left the test site before or during the test, because the subject got sick, for example. Similarly, a proctor may mark a subject as present, or flag the subject in some other way, after the test has already begun, even if the subject was marked as absent before the test began.

Having such data regarding attendance available enables an administrator to perform further statistical analysis and reporting. For example, an administrator may use the data to determine which subjects need to make-up or re-take a test.

In an example embodiment, the assessment administrator application is Turning Technologies High Stakes TurningWeb application and the test proctoring application is Turning Technologies High Stakes Desktop Application.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A method of administering a high stakes test, the method comprising:
providing a proctor device;
receiving an encrypted offline data package at the proctor device;
the proctor device decrypting a first portion of the offline data package;
the proctor device authenticating a user as a proctor using the first portion of the offline data package;
associating the authenticated user with a test group;
decrypting a second portion of the offline data package based on the association, wherein at least one of the first portion and the second portion includes a test roster;
providing a plurality of response devices, each response device being associated with one of a plurality of subjects;
adjusting the test roster according to subjects physically present at a test site;
beginning a test;
receiving a plurality of signals at the proctor device from the plurality of response devices; and
ending the test.

2. The method of claim 1, further comprising:
determining a battery level of a first response device associated with a first subject, prior to beginning the test;
removing the first response device from the plurality of response devices upon determining that the battery level is below a predetermined threshold, prior to beginning the test; and
associating a second device with the first subject, prior to beginning the test.

3. The method of claim 1, further comprising:
after beginning the test, determining that a first response device associated with a first subject is non-functional;
temporarily suspending the test;
associating a second response device with the first subject; and
resuming the test.

4. The method of claim 1, wherein a plurality of the signals from the plurality of response devices includes a time stamp.

5. The method of claim 4, further comprising comparing time stamps from a plurality of signals to determine at least one of:
an amount of time that a particular subject takes to answer test questions, compared to an average time that the remaining subjects from the plurality of subject takes to answer test questions, and
an average amount of time that the plurality of subjects take to answer a first test question compared to an average amount of time that the plurality of subjects take to answer a second question.

6. The method of claim 1, further comprising monitoring the plurality of signals to determine if a first subject and a second subject are submitting the same responses to test questions.

7. The method of claim 1, further comprising decrypting the plurality of signals by the proctor device into a question identifier, a response identifier, and a response device identifier.

8. The method of claim 7, further comprising storing the question identifier, the response identifier, and the response device identifier at the proctor device.

9. The method of claim 7, further comprising transmitting the question identifier, the response identifier, and the response device identifier from the proctor device to a server.

10. The method of claim 9, further comprising:
determining that at least one of an expected response identifier is missing from the server;
identifying the response device identifier associated with the missing expected response identifier;
identifying a proctor device associated with the identified response device identifier; and
logging on to the identified proctor device to determine whether the missing expected response identifier is present on the identified proctor device.

11. A method of administering a high stakes test, the method comprising:
providing a proctor device;
providing a plurality of response devices, each response device being associated with one of a plurality of subjects;
beginning a test;
receiving a plurality of signals at the proctor device from the plurality of response devices;
decrypting the plurality of signals by the proctor device into a question identifier, a response identifier, and a response device identifier;
storing the question identifier, the response identifier, and the response device identifier at the proctor device;
transmitting the question identifier, the response identifier, and the response device identifier from the proctor device to a server;
ending the test;
determining that at least one of an expected response identifier is missing from the server;
identifying the response device identifier associated with the missing expected response identifier;
identifying a proctor device associated with the identified response device identifier; and
logging on to the identified proctor device to determine whether the missing expected response identifier is present on the identified proctor device.

12. The method of claim 11, further comprising transferring the missing expected response identifier from the identified proctor device to the server, upon determining that the missing expected response identifier is present on the identified proctor device.

13. The method of claim 11, further comprising transferring the missing expected response identifier from the identified response device to the identified proctor device, upon determining that the missing expected response identifier is not present on the identified response device.

14. The method of claim 13, further comprising transferring the missing expected response identifier from the identified proctor device to the server, after transferring the missing expected response identifier from the identified response device to the identified proctor device.

15. The method of claim 11, further comprising transferring the missing expected response identifier from the identified response device to the server, upon determining that the missing expected response identifier is not present on the identified response device.

16. A method of administering a high stakes test, the method comprising:
providing a proctor device;
providing a plurality of response devices, each response device being associated with one of a plurality of subjects;
beginning a test;
receiving a plurality of signals at the proctor device from the plurality of response devices;
determining that a first response device associated with a first subject is non-functional;
temporarily suspending the test;
associating a second response device with the first subject; and
resuming the test.

17. The method of claim 16, further comprising decrypting the plurality of signals by the proctor device into a question identifier, a response identifier, and a response device identifier, and storing the question identifier, the response identifier, and the response device identifier on the proctor device.

18. The method of claim 17, wherein the step of associating the second response device with the first subject includes:
identifying the response identifiers stored on the proctor device that are associated with the first response device; and
loading the identified response identifiers onto the second response device.

19. The method of claim 17, further comprising transmitting the question identifier, the response identifier, and the response device identifier from the proctor device to a server.

20. The method of claim 16, further comprising:
receiving an encrypted offline data package at the proctor device;
the proctor device decrypting a first portion of the offline data package;
the proctor device authenticating a user as a proctor using the decrypted portion of the offline data package;
associating the authenticated user with a test group; and
decrypting a second portion of the offline data package based on the association, wherein at least one of the first portion and the second portion includes a test roster.
